(19) United States
(12) Patent Application Publication
(10) Pub. No.: US 2014/0095610 A1
(43) Pub. Date: Apr. 3, 2014

(54) IMPULSE LIKE

(71) Applicants: Deepti Bhardwaj, Sunnyvale, CA (US); Huang Victor, Castro Valley, CA (US)

(72) Inventors: Deepti Bhardwaj, Sunnyvale, CA (US); Huang Victor, Castro Valley, CA (US)

(21) Appl. No.: 13/792,206

(22) Filed: Mar. 11, 2013

Related U.S. Application Data
(63) Continuation-in-part of application No. 13/631,977, filed on Sep. 29, 2012.

(51) Int. Cl. H04L 29/08

(52) U.S. Cl. CPC H04L 67/22
USPC 709/204

(57) ABSTRACT

A method, system, and apparatus for presenting information in a social network is disclosed. In some embodiments, this includes displaying an element in a user profile to a third party user, providing an option to the third party user to indicate the third party user's level of satisfaction with the element, wherein the option includes a first option to indicate a first level of satisfaction, wherein the first option is associated with a first option counter, and a second option to indicate a second level of satisfaction, wherein the second option is associated with a second option counter, upon the third party user selecting at least one of the options, incrementing at least one of the option counters, and updating the display of the element to indicate the incrementing of at least one of the option counters.

### CROSS-REFERENCE TO RELATED APPLICATION

This application is a continuation-in-part of, pending prior U.S. patent application Ser. No. 13/633,197 filed on Sep. 29, 2012.

### BACKGROUND

1. Field of the Invention

This invention generally relates to social networks, and more particularly to creating more accurate profiles in social networks.

2. Description of Related Art

With current social networks, users are able to connect to and interact with other users. Current social networks facilitate this interaction by allowing users to create user profiles. Typically, this user profile is populated with information supplied by the user to the social network. For example, the user may supply the user's name, likes and dislikes, pictures, and occupation, among others, to the social network. The information supplied by the user is then made available to others by the social network. Others may then identify the user by the information supplied (e.g. name, picture, etc.), and connect with the user.

However, current social networks allow only a user to populate the user's profile. This results in only one perspective being reflected in the user profile (e.g. that of the user). There is a need, therefore, for more accurate user profiles in social networks.

### SUMMARY

In some embodiments, the present invention provides a method to allow a third party user to express the third party user's level of satisfaction with an element in a user profile. Multiple tiers of agreeing or liking an element are provided to better distinguish between regular likes and stronger likes.

This summary is provided to give the reader a quick overview of the invention. The summary does not necessarily include each and every element of the claimed invention, nor does the invention necessarily contain everything in this summary.

### DESCRIPTION OF THE DRAWINGS

FIG. 1 illustrates a screen with a user profile and comments in accordance with some embodiments.

FIG. 2 illustrates a screen with a story and chapters in accordance with some embodiments.

FIG. 3 illustrates a method to present information on a user in a social network in accordance with some embodiments.

### DETAILED DESCRIPTION

The present invention provides a method to populate a social network user profile based on information supplied by at least one third party. The user profile is created by the user, but the user profile is substantially populated by other users. Further, in some embodiments, the user has limited control over the user profile after the user profile has been created.

When a user creates a user profile on a social network, the user is asked to provide a relatively small amount of personal information. In some embodiments, this may include a first and last name, and a picture. In some embodiments, this may include only an email address. The amount of information provided by the user may vary, but the information provided by the user should be sufficient for others to identify the user. For example, a user profile with a cartoon avatar and a nickname may not necessarily allow other users to readily identify the user. In the opposite case, a user profile with a current photo will likely allow others to identify the user. An email address may also be requested of the user at the time the user profile is created. Since friends, family, co-workers, etc. may communicate with the user via the user's current email address, seeing the user's current email address associated with the profile may assist other such users to identify the user. As stated above, the information requested of the user may vary (e.g. current occupation, age, date of birth, location, etc.), but should be kept relatively low.

After the user creates a user profile with the initial information, the user, in some embodiments, is not allowed to add any other information to the user profile. Rather, the user must rely on other users to populate the user profile. This allows for third party perspectives to be reflected in the user profile, as opposed to just the user's perspective in current social networks. However, not any third party user may populate the user profile. The only other users who should be able to populate the user profile are users who are qualified to describe the user (e.g. friends, family, co-workers, teachers, etc.).

There are multiple ways to determine who is qualified to populate a user profile. In some embodiments, a user may request a friend to populate the user's profile. If the friend is already part of the social network, the request may be sent via the social network's communication tools. If the friend is not part of the social network, the request may be sent via email, such request also including an invitation to join the social network. If a user requests a friend to populate the user's profile, it can be assumed that the friend is qualified to populate the user's profile, and that the user trusts the friend.

In some embodiments, a third party user (e.g. a friend, a co-worker, a family member, etc.) may ask the user to populate the user's profile. The user may then allow or reject the third party user's request based on the user's relationship with the third party user. For example, if the third party user is a co-worker of the user, the user may feel comfortable allowing the third party user to populate the user's profile. However, if the third party user is simply an acquaintance of the user, the user will probably not feel comfortable allowing the acquaintance to populate the user's profile since the third party user may not be qualified (e.g. not know enough about the user.)

In some embodiments, the user is not allowed to edit or delete what the third party user populates the user profile with. For example, if the user allows a friend to write to the user's profile, the friend may write anything the friend deems appropriate. The information written by the friend may be true, false, misleading, embarrassing, etc., but the user will have no means to delete or edit such information. Once the third party user has been granted permission to write to the user's profile, the third party user may write any information about the user at any time.

Since granting permission to write to a user profile carries potentially serious consequences (e.g. defamation, embarrassment, etc.), a warning should be issued to the user by the social network. For example, “WARNING: Once granted permission, John Doe will be able to write whatever he wants about you. He may write hurtful, embarrassing, or personal facts about you that others will be able to see. He may even write lies about you. However, we will be unable to remove such language, and you will not be able to either. This permission grant is also permanent. You may have a great relationship with him now, but if it deteriorates in the future, you will be unable to revoke his permission to write to your profile. Do you wish to continue?” may be displayed on a display device, such as a computer monitor or a mobile device's screen.

The above warning may be used in embodiments wherein the permission grant is permanent. However, in some embodiments, the permission grant may be temporary. For example, a user may allow a co-worker to write to the user's profile for as long as the two work at the same company. A user may allow a friend to write to the user's profile for a period of five years with the option to renew for another defined time period. A user may allow a family member to write to the user profile indefinitely, but with the option to revoke the permission with no notice or with a pre-defined notice period.

Some users may feel uncomfortable with third party users having an unrestricted ability to write about the user. In some embodiments, privacy controls may be used to minimize the amount of damage that can be caused by a third party user. For example, the user may only allow other connected users (e.g. friends, family, etc.) to view the user's profile, while the general public may not.

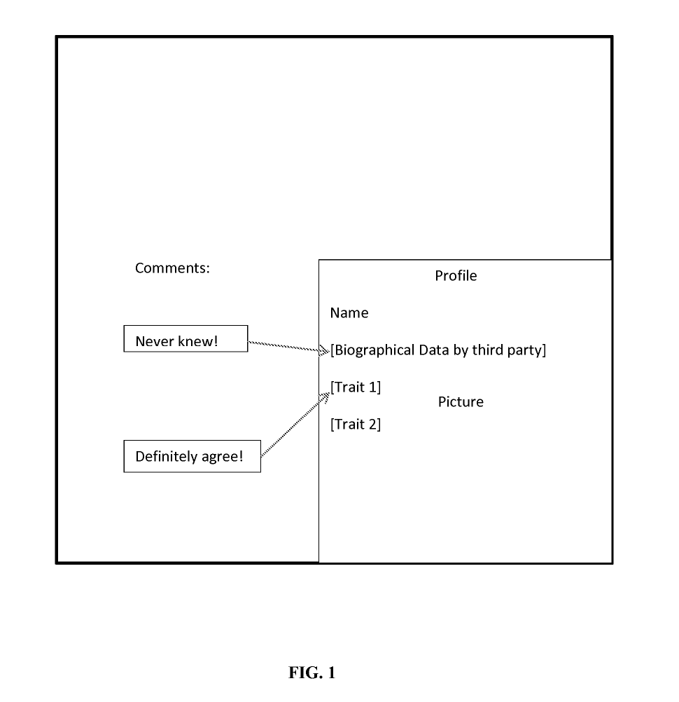

In some embodiments, comments may be used by other third party users to help prove the veracity, or lack thereof, of information supplied by a third party user. For example, suppose a user grants permission to a friend to write on the user's profile. Later, the friendship between the user and the friend deteriorates, and the friend now writes lies on the user's profile. If other third party users see the lies, those third party users may comment on the lies, provided that the other third party users have a connection with the user (e.g. user has granted permission to the other third party users to write to the user's profile). In some embodiments, the comments may appear next to the information provided by the friend. FIG. 1 illustrates a screen with a user profile and comments in accordance with some embodiments. These comments may be simple statements that help prove the veracity of the third party's information, such as “I agree!” or “Definitely” These comments may also be more detailed statements that question the truth of the third party's information, such as “What makes you say this? I've known the user for 10+ years, and this seems totally out of character.” Though lies or other defamatory statements may be not be removed from the profile in some embodiments, sufficient comments countering the defamatory statements should be able to expose such statements as such.

In some embodiments, third party information may be presented as a “profile” of a user. For example, Friend A may write a profile of the user, and Friend B may write another profile of the user. The two profiles may share common information, or may have conflicting information (e.g. “the user likes rock music” from Friend A, and “the user hates rock music” from Friend B). No profile should be deemed “more correct” than any other profile. These are all perspectives from people who are qualified to write about the user, and they may reveal different sides to a person.

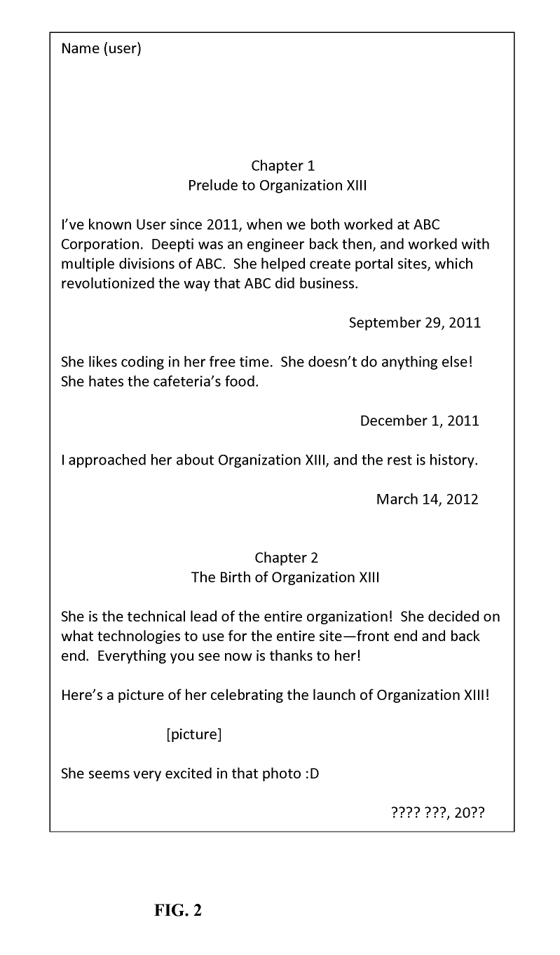

People, however, are not static. Significant events may alter a person's behavior, a person's attitude, and a person's way of thinking Thus, in some embodiments, a profile may not be enough to fully capture the user. In addition to the profile, or in place of the profile in some embodiments, a “story” may be written by third party users. These stories may be broken down into “chapters,” which are significant portions of the user's life, as deemed by a third party user. For example, suppose a user asks a friend to populate the user's profile. The friend may provide a general profile of the user, which may include general statements such as “User likes books a, b, c, and his favorite movies are d, e, f. User is a nice guy who cares about his friends.” The friend may then write a story about the user, and the story may be associated with the profile (e.g. the profile may be considered a cover page for the story”). FIG. 2 illustrates a screen with a story and chapters in accordance with some embodiments. Having a story reveals how the user and the relationship between the user and the friend evolved over time, in the eyes of the friend. Reading the story may allow viewers to understand why the friend says the things he's said, and help to validate the statements made by the friend in the user's profile. The story also allows the friend to post information about events relating to the user contemporaneously. For example, if the friend and the user attend a wedding, the friend may write about the user's behavior, actions, etc. in the story during or shortly after the wedding.

As with third party perspectives of individuals, third party perspectives of institutions may help to give a more accurate and complete profile. For example, a “user” may be business. Customers or clients of the business may ask to write about the business or vice versa if the business is seeking feedback. In some embodiments, the business user may allow any user to write a profile of the business. In some embodiments, the business user may allow only individual users who have bought the business' products or otherwise interacted with the business. A receipt or other business log may be presented to the business user for verification prior to allowing an individual user write a profile of the business user. Individual users (e.g. reviewers) may state their opinions of the business, its customer service, its product quality, etc. The business may then in turn review the reviewer. For example, suppose the business user is a restaurant. The business user may review the reviewer to determine how the reviewer compares to other reviewers in terms of food preparation knowledge, food presentation knowledge, experience with diverse cuisines, etc. This information may be supplied by the reviewer's connections (e.g. friends and family). If a friend of the reviewer writes in the reviewer's profile that the reviewer travels the world just to eat different foods, has graduated from a prestigious culinary academy, and works in a prestigious restaurant, the business may give more weight to the reviewer's review. On the other hand, if the reviewer's profile is blank (e.g. no connections), then the business may assume that the profile was a fake profile created by a disgruntled customer to add more negative reviews. With third party perspectives on reviewers, businesses (and other potential customers of the business) may have a better idea of which reviews are legitimate, and which reviews to give more weight.

Similarly, institutions may write profiles about individual users. For example, a university may state that the user attended the university, provide an unofficial transcript or list of courses taken by the user at the university, and state when the user graduated and with what degree. In another example, a DMV may write a profile about a licensed driver, indicating what class of automobiles the licensed driver may operate, when the license expires, whether the licensed driver is an organ donor, etc. In yet another example, a medical institution may write a profile and a story of a user, indicating what illnesses the user has contracted in a period of time, and what remedies have been applied. The information provided by institutions can provide substantial insight to people interested in the user (e.g. other universities determining whether to admit the user, other doctors determining what treatment to recommend, etc.).

By having multiple qualified third parties provide their perspectives, a more complete and accurate profile can be created. This may be beneficial to other persons who wish to better know the person, such as HR representatives who are considering the user for a job, universities who are considering the user for admission, other users who may be searching for a potential romantic relationship, businesses who are trying to cater to the user's likes and dislikes, etc. However, third party perspectives need not be limited to a person or an institution.

Third party users may also provide information about a relationship. For example, suppose there are three friends: Friend A, Friend B, and Friend C. Friend A may write a profile about the relationship between Friend B and Friend C. Friend B may have an idea of what his relationship with Friend C is like, just as Friend C may have an idea of what his relationship with Friend B is like, but Friend A may have a completely different view on the relationship between Friend B and Friend C. These again may be competing and contradictory views, but no one view is more correct. Taken together, these views provide a more complete profile of the relationship between Friend B and C. The relationship need not be limited to two people. For example, a user can write a profile on the relationship of a group of friends. In this way, many profiles may be generated from a relatively small number of people. It should be noted that the above privacy controls may apply. Friend B and Friend C should feel that Friend A is qualified to write about both of them, and Friend A must request permission from Friend B and C to write a profile about the relationship.

A reputation score may be assigned to profiles. For example, a user profile which is routinely updated and includes positive characteristic traits may be assigned a high reputation score. On the other hand, a user profile which hasn't been updated in a long time and includes negative characteristic traits may be assigned a low reputation score. How reputation scores are calculated may vary. Some factors to include in some embodiments may include:
Freshness: how often a user profile is updated, when was the last time the user wrote about another user, etc.
Positive traits: simple data analytics (e.g. text search) may be used to determine how often a positive trait appears in profiles written by third party users about the user. For example, if “hard-working” consistently appears, the reputation score may increase
Number of profiles: the higher number of profiles written about the user from third parties, the higher the reputation score.
Reputation of third party users providing information about the user: if the reputation of a third party user is high, the third party user's reviews of the user may be given more weight than others.

The reputation score may be general, or may be field specific. For example, a user may have a general reputation score, or an engineering reputation score in some embodiments. The engineering reputation score may be based on analyzing the user's work experience, accomplishments, etc. as provided by technical third party users, whereas a general reputation score may be based on analyzing all of the user's profiles written by third party users.

With a reputation score, other users of the social network may identify top users in a specific field. For example, HR representatives looking to fill an attorney position may search for profiles with a high reputation score in the legal field.

In some embodiments, there may be list of top users that resets periodically. For example, there may be a weekly top 10 engineer list that resets every Sunday. If reputation is based on freshness, this periodic reset helps prevent “legacy” (e.g. those with a very high reputation score from the past, but with a low freshness score) top performers from always remaining on the list.

Users in this type of social network have a significant impact on other users. Deleting a user account can potentially impact many profiles if the user wrote a lot of information about others. In some embodiments, the social network may determine that the user owns all of the information the user writes. Thus, the user deleting the user account would remove all of the user's reviews, profiles, etc. that the user wrote about other people. In some embodiments, the social network may determine that the user owns all of the information other people write about the user. In this case, the user deleting the user account would remove all of the information supplied by other people about the user. Determining what information to delete may also depend on local privacy laws. For example, in jurisdictions with a “Right to be Forgotten,” deleting a user account may remove all traces of the user (e.g. removing profiles written about other users). In some embodiments, the social network may provide options to the user when deleting the user account. For example, if the user no longer wants an account, but his or her friends have informed the user that they want to retain the user's reviews of them, the user may opt for a “Proof of Existence” deletion, where the user account is removed, but traces of the user can be found in his or her friends' profiles via comments, profiles, stories, etc.

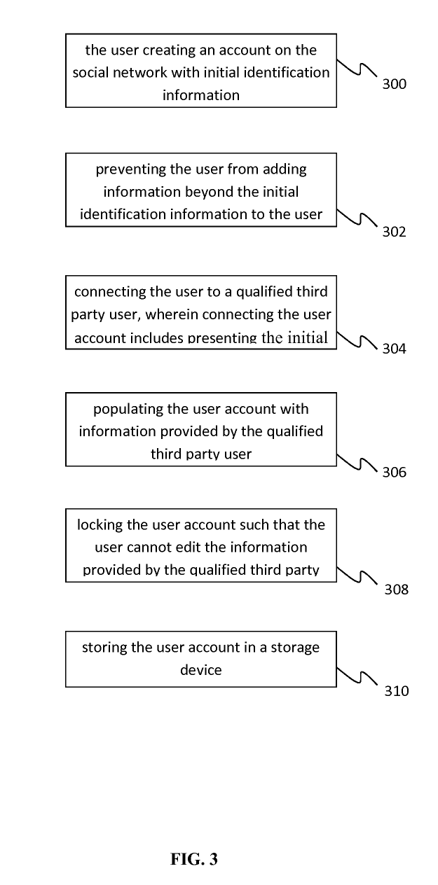

FIG. 3 illustrates a method to present information on a user in a social network in accordance with some embodiments. In step 300, a user account is created on the social network with initial identification information. In step 302, the user is prevented from adding information beyond the initial identification information to the user account. In step 304, the user is connected to a qualified third party user, wherein connecting the user account includes presenting the initial identification information to the qualified third party user. In step 306, the user account is populated with information provided by the qualified third party user. In step 308, the user account is locked such that the user cannot edit the information provided by the qualified third party user. In step 310, the user account is stored in a storage device.

A third party may occasionally see information about the user, or an element of the user's profile that strongly resonates with the third party. Such information may illicit an immediate and powerful reaction from the third party, or an “impulse.” For example, suppose User B writes that User A is a “good son.” User C, who is User A's mother, may see that element on User A's profile and immediately agree with that information supplied from User B. In some embodiments, User C may be given the option of “agreeing” with (or “liking”) the element supplied from User B, or “impulse agreeing” with the information. If User C chose the “impulse agree” option, viewers of User A's profile would see that User C strongly agreed with the information supplied by User B. The two options may be presented next to each other, or the “impulse agree” may be triggered by multiple and rapid mouse clicks or taps on the agree option. In other words, the impulse agree option is selected by selecting the agree option multiple times in rapid succession. Similarly, in some embodiments, there may be an option for disagree and impulse disagree.

In some embodiments, the reaction need not be an impulse. The third party may simply wish to indicate a higher level of agree, such as strongly agree, as opposed to a simple “agree.” Multi-tiered agrees or disagrees allow for a more complete picture. For example, in a single tier system, a review of a product may receive many “likes” or “agrees.” However, these “agrees” are indistinguishable from one another. User A may moderately agree with the review, while User B may strongly agree with the review, but this difference will be invisible to a third party user viewing the review.

The above examples illustrate how “agree” or “like” may be tiered into a simple “agree” and a “strongly agree” or a simple “like” and a “very much like.” However, in some embodiments, multiple tiers may be used. For example, there may be options for slightly agree, agree, strongly agree, and absolutely agree.

Multi-tiered agrees or likes provide a new dimension in profiles. Continuing with the above example, User B writes that User A is a good son. Not too many people may know this aspect or trait of User A. Thus, the “good son” trait may not receive many agrees. This lack of agrees, likes, or comments supporting the trait may cause other traits to be more prominently displayed in User A′s profile. For example, suppose User B writes that User A likes hamburgers, and User D, User E, and User F all agree with that trait. A third party user viewing User A's profile will see that the “good son” trait received only one “like” from User C, whereas the “likes hamburgers” trait received three “likes” from Users D, E, and F, and may conclude that the “likes hamburgers” is a stronger trait of User A. However, with a multi-tiered structure, more weight may be given to different “likes.” User C “impulse liked,” or “strongly agreed” with the “good son” trait, while Users D, E, and F “liked” or “agreed”' with the “likes hamburgers.”

In some embodiments, for example, an “impulse like” may be the equivalent of multiple regular likes. If impulse likes were the equivalent of ten regular likes, the “good son” trait will appear as a stronger trait of User A. If a score was assigned to each trait, the “good son” trait may receive a “10,” whereas the “likes hamburgers” trait may receive a “3.” In some embodiments, impulse likes may be tracked and displayed separately from regular likes. This may give more information to viewers of the user's profile. For example, a third party user will be able to see that the “good son” trait received one impulse like, but zero regular likes, and the “likes hamburgers” trait received zero impulse likes, but three regular likes. Likewise, each trait may have two or more scores. The “good son” trait may receive a “1” impulse like score, but a “0” regular like score. The “likes hamburgers” trait may receive a “0” impulse like score, but a “3” regular like score. Though the above examples uses a two tiered “like” system with an impulse like, a wide variety of combinations is possible. For example, in some embodiments, a social network may have several tiers of likes or agrees, with some tiers being weighed more than others. In some embodiments, a total score may be given for each trait in addition to the number of each type of like. In the example above, the total score for the “good son” trait would be 1*10+0*1=10. The number for each type of like would be 1 impulse like and 0 regular likes. In some embodiments, the total score may be given instead of the number of each type of like, or vice versa.

In some embodiments, it may be preferable to impose a limit on a type of like that is given more weight, or higher-tiered likes. For example, if users can “impulse” like limitlessly, the significance of the impulse like would be diminished. If users wanted to make an element rise to the top (e.g. the strongest trait of a user, or the most helpful review of a product), or otherwise make their opinion more significant than their peers', such users may use the impulse like exclusively. This may cause other users to use the impulse like exclusively, and the “regular” like may no longer be used or relevant. In some embodiments, a social network may allow users to use an impulse like, or other higher-tiered like, a limited number of times in a given time period. For example, a user may only be able to use five impulse likes per month. Other limitations may be imposed, such as number of impulse likes per month per profile. For example, User A may be given five impulse likes per month to use on User B's profile, and another five impulse likes per month to use on Company C's product.

In some embodiments, the following steps may be taken, in any order, to show a third party's level of satisfaction with an element in a user profile:

display an element in a user profile to a third party user

provide an option to the third party user to indicate the third party user's level of satisfaction with the element, wherein the option includes: a first option to indicate a first level of satisfaction, wherein the first option is associated with a first option counter and a second option to indicate a second level of satisfaction, wherein the second option is associated with a second option counter

upon the third party user selecting at least one of the options, increment at least one of the option counters

updating the display of the element to indicate the incrementing of at least one of the option counters

Continuing the above “good son” trait and “likes hamburger” trait example, the element presented in the user profile may be the “good son” trait. A third party user, User C, may see the “good son” element and strongly agree with the element. In other words, User C has a very high level of satisfaction with the element. User C has the option to indicate the level of satisfaction. One option is the “regular” like, and the second option is the “impulse” like. Since the second option indicates a higher level of satisfaction, User C selects the second option. After User C has selected the second option, the second option counter may increment. The second option counter indicates how many times different users have selected the second option for the element. User C cannot select the second option again to increment the second option counter again. A given user is only able to “regular” like or “impulse” like an element once in this example. The display is then updated to show the incremented second option counter. In some embodiments, this may include displaying the second option counter's stored value next to the element. In this case, it would display “1” next to the impulse like option for the “good son” trait. Further, if the number of impulse likes is limited as discussed above, User C's impulse like, or second option, usage counter may be adjusted. If User C is only allowed five impulse likes per month, the usage counter may be decremented from five, or incremented from zero, depending on the system of tracking utilized. Upon being decremented to zero, or incremented to five, User C no longer has the option of using impulse like until the next month, when the usage counter resets.

It should be noted that the social network described herein need not have only third party perspectives. Certainly, one of the most important perspectives of the user is that of the user herself. In presenting an accurate and complete profile of the user, some embodiments may include a profile or a story of the user as the user sees it.

The examples provided herein illustrate some embodiments. There are several other embodiments and variations that those with ordinary skill in the art will appreciate.

What is claimed is:

1. A method for presenting information in a social network, comprising:
displaying an element in a user profile to a third party user;
providing an option to the third party user to indicate the third party user's level of satisfaction with the element, wherein the option includes:
a first option to indicate a first level of satisfaction, wherein the first option is associated with a first option counter; and
a second option to indicate a second level of satisfaction, wherein the second option is associated with a second option counter;
upon the third party user selecting at least one of the options, incrementing at least one of the option counters; and
updating the display of the element to indicate the incrementing of at least one of the option counters.

2. The method as recited in claim 1, further comprising calculating a score based on the first option counter and the second option counter.

3. The method as recited in claim 1, wherein the second level of satisfaction is a higher level of satisfaction than the first level of satisfaction, and wherein the second level of satisfaction is an impulse.

4. The method as recited in claim 1, wherein the second option is further associated with a usage counter.

5. The method as recited in claim 4, further comprising adjusting the usage counter each time the second option is selected.

6. The method as recited in claim 5, further comprising restricting the third party user from selecting the second option upon the usage counter reaching a predetermined limit.

7. The method as recited in claim 6, further comprising resetting the usage counter at a predetermined time period.

8. The method as recited in claim 1, wherein selecting the second option includes selecting the first option multiple times in rapid succession.

9. The method as recited in claim 2, further comprising arranging elements of the user profile based on each of the element's calculated score.

10. The method as recited in claim 1, wherein a low level of satisfaction indicates dissatisfaction.

11. The method as recited in claim 9, wherein arranging elements of the user profile includes providing a first arrangement and a second arrangement, wherein the first arrangement is based on the calculated score and the second arrangement is based on the second option counter.

12. A system for presenting information in a social network, the system comprising a display device and a processor configured to:
display an element in a user profile to a third party user on the display device;
provide an option to the third party user to indicate the third party user's level of satisfaction with the element, wherein the option includes:
a first option to indicate a first level of satisfaction, wherein the first option is associated with a first option counter; and
a second option to indicate a second level of satisfaction, wherein the second option is associated with a second option counter;
upon the third party user selecting at least one of the options, increment at least one of the option counters; and
update the display of the element to indicate the incrementing of at least one of the option counters.

13. A computer program product for presenting information in a social network comprising a non-transitory computer readable medium with instructions embodied therein for:
displaying an element in a user profile to a third party user;
providing an option to the third party user to indicate the third party user's level of satisfaction with the element, wherein the option includes:
a first option to indicate a first level of satisfaction, wherein the first option is associated with a first option counter; and
a second option to indicate a second level of satisfaction, wherein the second option is associated with a second option counter;
upon the third party user selecting at least one of the options, incrementing at least one of the option counters; and
updating the display of the element to indicate the incrementing of at least one of the option counters.
